(19) United States
(12) Patent Application Publication
(10) Pub. No.: US 2018/0060904 A1
(43) Pub. Date: Mar. 1, 2018

(54) ALLOCATION OF WIRELESS COMMUNICATION ACCESS TO MOBILE DEVICES

(71) Applicant: FreeMo, Inc., Kirkland, WA (US)

(72) Inventors: LEIGH HUNT, Kirkland, WA (US); Umesh Kalaspurkar, Jersey City, NJ (US)

(21) Appl. No.: 15/246,158

(22) Filed: Aug. 24, 2016

(51) Int. Cl. G06Q 30/02; H04L 29/08; H04W 4/02; H04M 3/42; H04L 29/06

(52) U.S. Cl. CPC G06Q 30/0245; H04L 67/306; H04W 4/023; H04W 84/042; H04L 63/102; G06Q 30/0267; G06Q 30/0269; H04M 3/42178

(57) ABSTRACT

Wireless communication access is allocated to a mobile device. Hardware inputs of a mobile device measure an interaction value. The interaction value is converted to a discrete unit of wireless communication access. The mobile device receives access to the discrete unit.

### TECHNICAL FIELD

This disclosure relates generally to wireless communication and in particular to wireless communication with mobile devices.

### BACKGROUND INFORMATION

As mobile devices become ubiquitous, wireless communication technologies have evolved. Mobile devices such as tablets and smartphones use wireless communication technologies such as cellular data, WiFi, and BlueTooth. Often times, the different wireless communication technologies operate within different radio frequency bands. The advancement of these wireless communication has encouraged the use and consumption of wireless data from the different wireless data sources. Managing allocation of access to different wireless communication technologies for mobile devices is desirable for a variety of reasons.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 includes an example mobile device that can be allocated wireless communication access, in accordance with an embodiment of the disclosure.

FIG. 2 illustrates a system for allocating wireless communication access that includes a mobile device, an allocation server, a wireless network, and a mobile virtual network operator (MVNO), in accordance with an embodiment of the disclosure.

FIG. 3 illustrates a system for allocating wireless communication access that includes a mobile device, a wireless network, and a hybrid allocation MVNO server, in accordance with an embodiment of the disclosure.

FIG. 4 illustrates a system for allocating wireless communication access that includes a mobile device and a wireless network, in accordance with an embodiment of the disclosure.

FIG. 5 illustrates an example method of allocating a calculated unit of cellular service to a mobile device, in accordance with an embodiment of the disclosure.

FIG. 6 illustrates an example method of initiating an access allocation and accessing a unit of cellular service by a mobile device, in accordance with an embodiment of the disclosure.

FIGS. 7A-7D illustrate example inputs to a mobile device for gaining access to wireless communication, in accordance with an embodiment of the disclosure.

### DETAILED DESCRIPTION

Embodiments of an apparatus, system, and method of allocating wireless communication are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout this specification, several terms of art are used. These terms are to take on their ordinary meaning in the art from which they come, unless specifically defined herein or the context of their use would clearly suggest otherwise.

For the purposes of this application, a “mobile device” includes smartphones, tablets, and smart-watches. Smartphones and tablets typically have operating systems capable of running mobile applications. Smartphones and tablets include a processor, a memory for storing executable computer code and media such as photos, videos, and music. Smartphones and tablets also have wireless communication radios that include the ability to connect the smartphone or tablet to other devices or computer networks using WiFi, BlueTooth, NFC (Near-Field Communication), and cellular (e.g. CDMA, GSM, 3G, 4G, LTE) protocols, for example. “Smart-watches” generally include at least one electronic displays, a processor, memory for storing media, and wireless communication radios to send and receive data.

The term “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. A server includes a network interface for sending and receiving packets that include data. The server computer may comprise one or more computational apparatuses and may use any of a variety of computing structures, arrangements, and compilations for servicing the requests from one or more client computers.

“Processing logic” may refer to any suitable data computation device or devices such as a processor, field-programmable gate array (FPGA), or otherwise. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

For the purposes of this disclosure, the term “cellular service” includes different categories of cellular service such as cellular data, voice minutes, text messages, and otherwise. An example unit of cellular data may be 1 GB of cellular data. An example unit of voice minutes may be 100 voice minutes of talk time. An example unit of text messages may be 500 text messages. “Text messages” may refer to Short Message Service (SMS) texts.

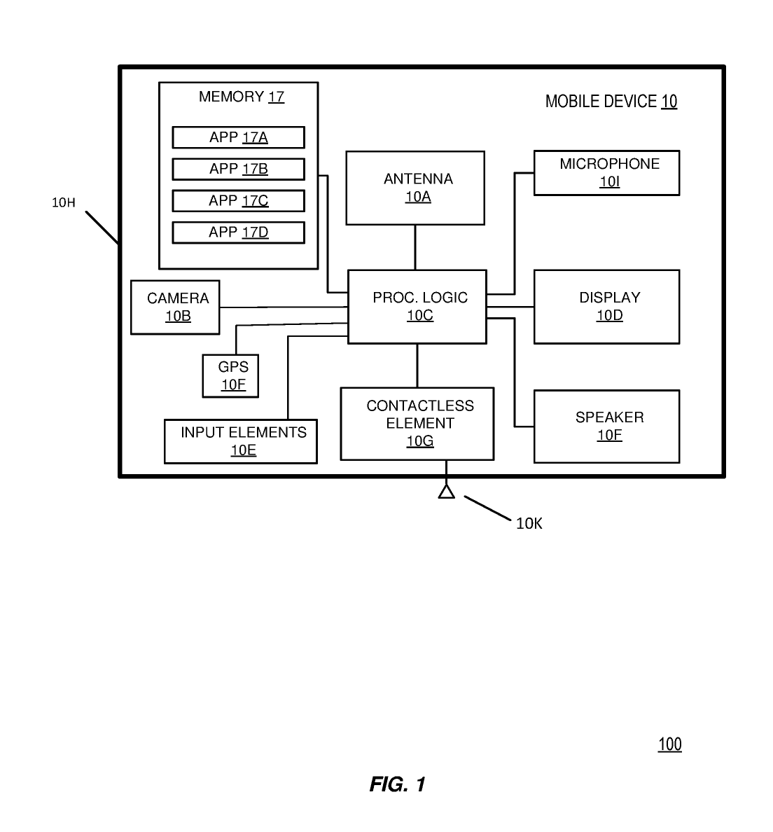

FIG. 1 shows an example mobile device 10, according to an embodiment of the invention. The mobile device 10 includes processing logic 10C (e.g., a microprocessor or FPGA) for processing the functions of the mobile device 10 and a display 10D to allow a user to see phone numbers, application interfaces, and other information and messages. The mobile device 10 may further include input elements 10E (e.g. buttons, touchscreen) to allow a user to input information into the device. A touch-screen interface may be included in the input elements 10E. The touch-screen interface may be disposed with the display 10D to sense a user's interaction with display 10D. In one embodiment, a capacitive touch-screen interface is overlaid on display 10D. A resistive touch-screen or other suitable technologies may also be implemented as the touch-screen. Example mobile device 10 also includes a speaker 10F to allow the user to hear voice communication, music, etc., and a microphone 10I to allow the user to transmit her voice through the mobile device 10. Example mobile device 10 also includes a camera 10B that may be implemented in the form of a CMOS (Complementary Metal-Oxide-Semiconductor) image sensor that is coupled to processing logic 10C. Global Positioning Satellite (GPS) receiver sensor 10F is also coupled to processing logic 10C, in the illustrated embodiment.

Example mobile device 10 includes antenna(s) 10A and contactless element 10G. Antenna(s) 10A may be configured for mobile phone communication (e.g. 3G, 4G, GSM, CDMA, and/or LTE) and wireless networking protocols such as IEEE (Institute of Electrical and Electronics Engineers) 802.11. The body 10H may be in the form a plastic substrate, housing, or other structure. An antenna 10k of contactless element 10G may be configured for sending and receiving wireless signals at a frequency specified by different wireless protocols such as NFC (Near Field Communication), BLE (Bluetooth Low Energy), RFID (Radio Frequency Identifier), or any other suitable form of short or medium range communications mechanism. Mobile device 10 may comprise components to both be the interrogator device (e.g. receiving data) and the interrogated device (e.g. sending data). Thus, the mobile device 10 may be capable of communicating and transferring data or control instructions via both cellular network (or any other suitable wireless network—e.g. the Internet or other data network) and short range communications.

Example mobile device 10 includes a memory 17 that can be included within the body 10H of the mobile device 10. Memory 17 is a computer-readable medium that is communicatively coupled to the processing logic 10C. Processing logic 10C may have read and write access to Memory 17. Memory 17 may be integrated into the physical packaging of processing logic 10C, in some embodiments. In the illustrated embodiment, memory 17 stores first application 17A, a second application 17B, a third application 17C, and a fourth application 17D. The memory 17 may be in the form of one or more memory devices (e.g., RAM, EEPROM, ROM chips), using any suitable mode of data storage. Mobile applications 17A, 17B, 17C, and 17D may be mobile applications such as a calculator, social media, a telephone, a text messaging application, email application, mapping applications, ride sharing applications, a lock-screen application, or otherwise. Other applications not specifically mentioned may also reside in memory 17 of mobile device 10.

Memory 17 may comprise instructions or code, executable by the processor for implementing a method of earning and then using a wireless communication allocation. In today's cellular service landscape, there are four large cellular carriers in the United States, Sprint™, AT&T®, Verizon™, and T-Mobile®. The cellular carries generally own their own infrastructure such as cellular towers and networks that support the cellular towers. These cellular carriers offer cellular service contracts that include a given amount of service that can include different categories of cellular service such as data, text, and talk (voice). Typically, a given monthly service fee gives a pre-determined cellular service to a given mobile device where the pre-determined cellular service has pre-defined usage constraints for that month. One example of cellular service for a month is 5 GB of data, 1000 minutes of talk/voice, and 1000 text messages. Another example of a monthly cellular service is 10 GB of data and unlimited talk and text.

In addition to the largest four cellular carriers, there are also MVNOs (Mobile Virtual Network Operators) that sell cellular service to consumers. MVNOs utilize the existing infrastructure of the big four cellular carriers by buying bulk/wholesale access to the infrastructure from the big four carriers and then selling cellular service to consumers. Example MVNOs include Boost Mobile, Cricket Wireless, TracFone, Virgin Mobile, and Straight Talk. Often times, MVNOs don't require yearly contracts that are billed monthly, but rather offer 30 day plans or discrete units of wireless data for a prepaid fee. Thus, the access to cellular service generally requires entering payment credentials (e.g. credit card or bank account) in exchange for cellular service, which leaves a user exposed to security breaches of their submitted payment credentials. The requirements to initially setup the cellular services are also a serious friction point to access cellular service as the setup process is involved. Furthermore, users often select a cellular service where they pay for more than what they use. For example, users who pay for 10 GB a month of data, but only use 7 GB of the data in the month are essentially overpaying for cellular service because the allocation of cellular service is fixed in the month, rather than dynamic. In other words, there is often an inefficient allocation of cellular access. A system and method of allocating cellular service without requiring the transmission of payment credentials and for more efficient allocation of cellular service would be desirable in today's cellular landscape.

A lock-screen application is described in this disclosure that allows users to earn interaction credits for interacting with content displayed on the lock-screen. The user can then initiate (with the mobile device) a redemption of the interaction credits for wireless communication access, in some embodiments. The wireless communication access may be for cellular service or for WiFi access, for example. The content rendered to the display within the lock-screen application can be advertisements or surveys. The user can earn interaction credits in a number of ways, for example, by viewing the advertisement (an impression), downloading additional content related to the advertisement, taking a survey rendered within the lock-screen application, redeeming an electronic coupon provided by the lock-screen application, making a purchase at an establishment/business advertised within the lock-screen application, “checking in” to a location proximate to a GPS reading of a mobile device executing the lock-screen application, or otherwise. The user interaction is measured by the mobile device to give user interaction credits that are linked to a user profile associated with the lock-screen application. The user interaction can be measured by a touch-screen interface of the mobile device. The user interaction can also be measured by a camera (e.g. a front facing camera on the same side of the mobile device as the display) of the mobile device. For example, the camera may record a time period (e.g. seconds) that a user looks at the content (e.g. advertisements) rendered to the lock-screen as a way of gauging impressions or quality of impression of the content. A higher quality impression (e.g. a user looking at the rendered content for a longer period of time as measured by the front facing camera) may generate a higher number of user interaction credits than a very short viewing of the rendered content by a user (as measured by the front facing camera). Processing logic of the mobile device may analyze video files recorded by the front facing camera to determine if the eyes of the user was viewing the content rendered on the lock-screen interface.

For the purposes of this disclosure, a “lock-screen” is a user interface element of a mobile device that appears on a display of mobile device when the mobile device is “awakened” from not being used or when the user elects to view the lock-screen of the mobile device (by selecting the power button of the mobile device, for example). The lock-screen limits the availability of the full suite of mobile applications installed on the mobile device until the lock-screen is “unlocked,” although some applications (e.g. calculator or camera) may be accessible to a user via the lock-screen. To “unlock” the mobile device, a user typically enters a numerical code on a touchscreen of the mobile device that may overlay a screen of the mobile device. A user may also “unlock” a lock-screen by performing a unique gesture that is sensed by a camera of the mobile device or touch screen. Some lock-screens can be “unlocked” by imaging a user's face with a front-facing camera of the mobile device. Some lock-screens are “unlocked” by swiping across the display in a certain direction or toggling a software button displayed on the screen. When the user successfully “unlocks” a lock-screen, they generally have access to the full suite of mobile applications that the mobile device has installed.

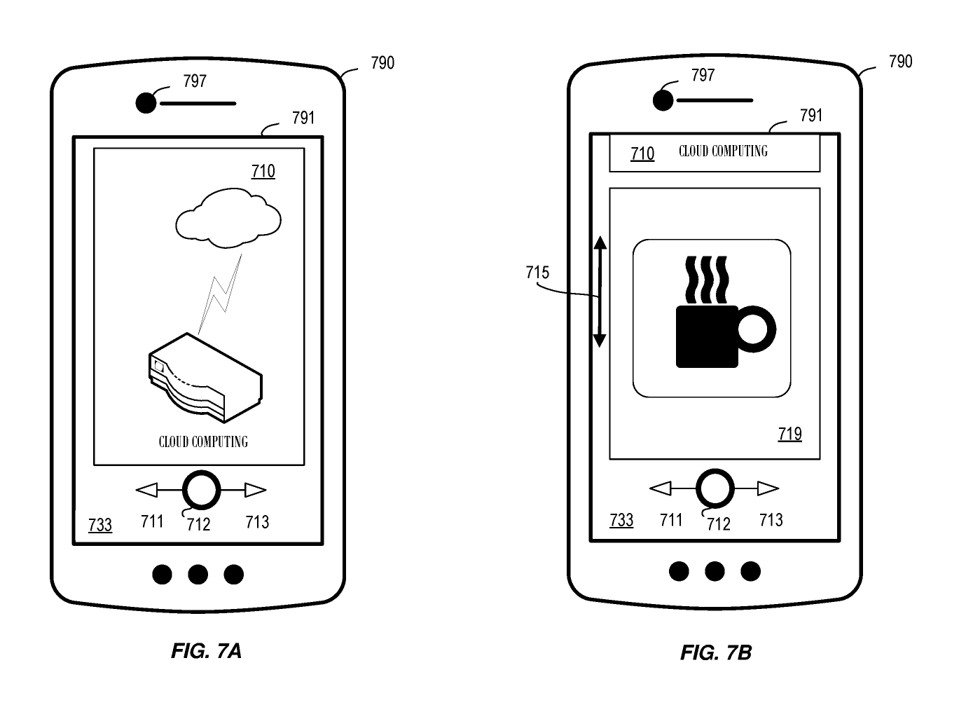

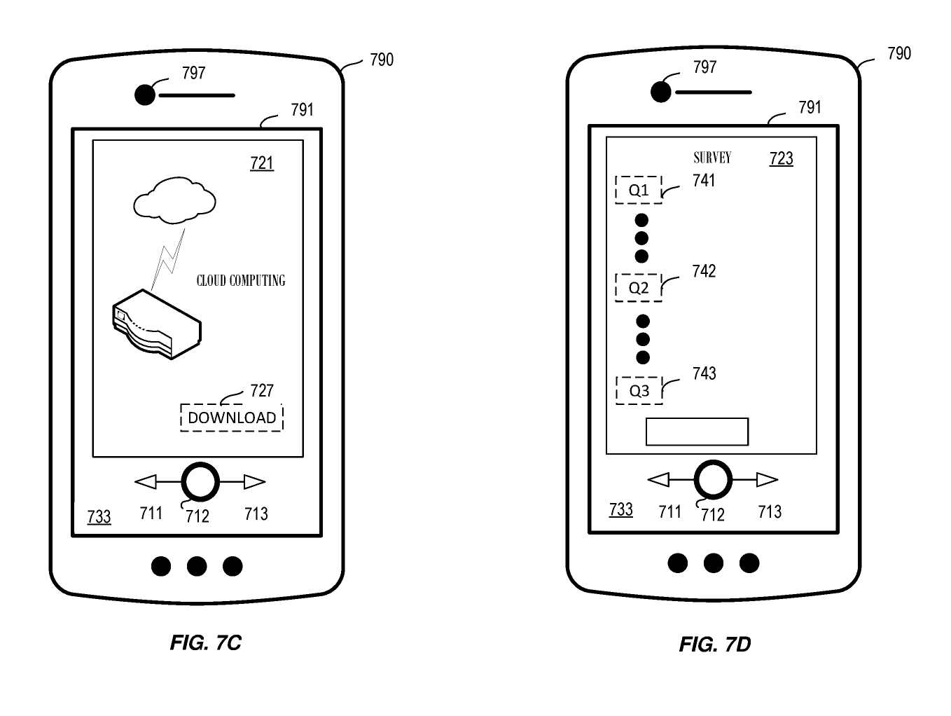

To better illustrate examples of the disclosure, attention is turned to FIG. 7A. FIG. 7A include a mobile device 790 having a display 791. Although not illustrated, display 791 may be overlaid with a touch-screen interface to sense a user's interactions with the mobile device. Example mobile device 790 also includes a front facing camera 797 that may be implemented in the form of a CMOS (Complementary Metal-Oxide-Semiconductor) image sensor, for example. Lock-screen application 733 is displayed on display 791, in FIG. 7A. The lock-screen application includes content 710 and slide button 712. FIG. 7B shows that a user can scroll 715 up and down by swiping up and down on the touch-screen interface. Scrolling 715 changes the content rendered to the lock-screen application. In FIG. 7A, content 710 includes an advertisement for cloud computing services. In FIG. 7B, a user has scrolled down to content 719, which is an advertisement for a coffee shop. A user may earn ten user interaction credits for each advertisement that they scroll through, for example. The lock-screen application may measure how long a user spends on each advertisement and assign a higher number of interaction credits for high quality impressions. The lock-screen may measure the quality or length of time of the impression via the touch-screen input, for example. The lock-screen application may continue to render different content (e.g. advertisements) to the display 791 as the user scrolls. In this way, the user can earn interaction credits linked to a user account/profile associated with the lock-screen application.

In the illustrated embodiment, a user can slide the slide button 712 left (swipe-left) to initiate a further interaction with a given content rendered to the lock-screen 733. For example, if the user is interested in viewing more about the cloud computing service of content 710, the user may swipe-left 711 to initiate further interaction with that content. “Swiping-left” could also include swiping left over the displayed content in addition to swiping the slide button 712 left. The user may earn additional interaction credits for swiping-left 711 since additional content will be displayed. In one example, swiping-left 711 reveals a coupon associated with the content. For example, swiping-left 711 for the cloud computing content 710 may render a special rate for a cloud computing service being advertised. If the user swipes-left 711 for content 719, a coupon for the coffee shop associated with content 719 may be presented to the user, for example. The user may earn additional user interaction credits for swiping-left 711 and interacting with additional content.

FIG. 7C illustrates an example content 721 that could be displayed as a result of a user swiping-left 711 from content 710. In content 721, a download interface 727 is offered to a user to download content associated with content 710. In one embodiment, the download interface initiates a download of a mobile application associated with content 710. In the illustrated embodiment, download interface 727 is illustrated as a software button within content 721. If the user elects to download additional content, they may be assigned additional interaction credits. In one embodiment, the lock-screen application receives a completion message indicating the additional content has been downloaded to the mobile device.

FIG. 7D illustrates content 723, which may be rendered as additional content when the user swipes-left 711. The survey in content 723 allows the user to answer survey questions by selecting different answers to Question 1 741 and Question 2 742. The user may also type in an answer to Question 3 743. When a user fills out the survey of content 723, the user may earn additional interaction credits corresponding to the amount of questions that the user answers in the survey.

The user may swipe-right 713 in the embodiments of FIGS. 7A-7D to exit the lock-screen application and have access to the full suite of mobile applications installed on mobile device 790. The lock-screen application is a useful application to have a user earn interaction credits that can be redeemed for wireless access because the lock-screen is shown when the user first starts to interact with the mobile device. Hence, a user can decide to swipe-right and access the full suite of mobile applications of the mobile device or choose to earn interaction credits for redemption for wireless communication access (e.g. cellular service) by interacting with the content of the lock-screen application 733. Using the lock-screen application is faster and more efficient than using a standard application that requires unlocking a lock-screen to access. The user may combine different interactions with the content of the lock-screen to generate a plurality of interaction credits. For example, the user may earn interaction credits for impressions, taking surveys, and downloading application or other content associated with content of the lock-screen. The interaction credits for these different user interactions may be combined for redemption of a discrete unit of cellular service.

In one embodiment, the lock-screen application causes processing logic of the mobile device (e.g. processing logic 10C) to query a GPS receiver for a GPS coordinate that functions as a location indicator. The mobile device transmits the GPS coordinates to a remote server associated with lock-screen application. The remote server searches a database of content that is associated with the GPS coordinate received from the mobile device. In one embodiment, content that is associated with a GPS coordinate is tagged with its own GPS coordinate. If the GPS coordinate of the content is within a pre-determined range (e.g. 2 miles) of the GPS coordinate received from the mobile device, the content is considered “location-relevant.” The remote server than sends the location relevant-content to the mobile device for rendering to the lock-screen. In this way, the lock-screen content may be location relevant. Other location indicators (aside from GPS coordinates) may include RFID data, Bluetooth signals, and WiFi signals. RFID data may be sensed from an RFID tag that is associated with a location. Beacons may utilize BLE (BlueTooth Low Energy) protocols to provide location data to a mobile device, for example. WiFi networks can be gleaned from WiFi signals and then checked against an online WiFi database to determine location.

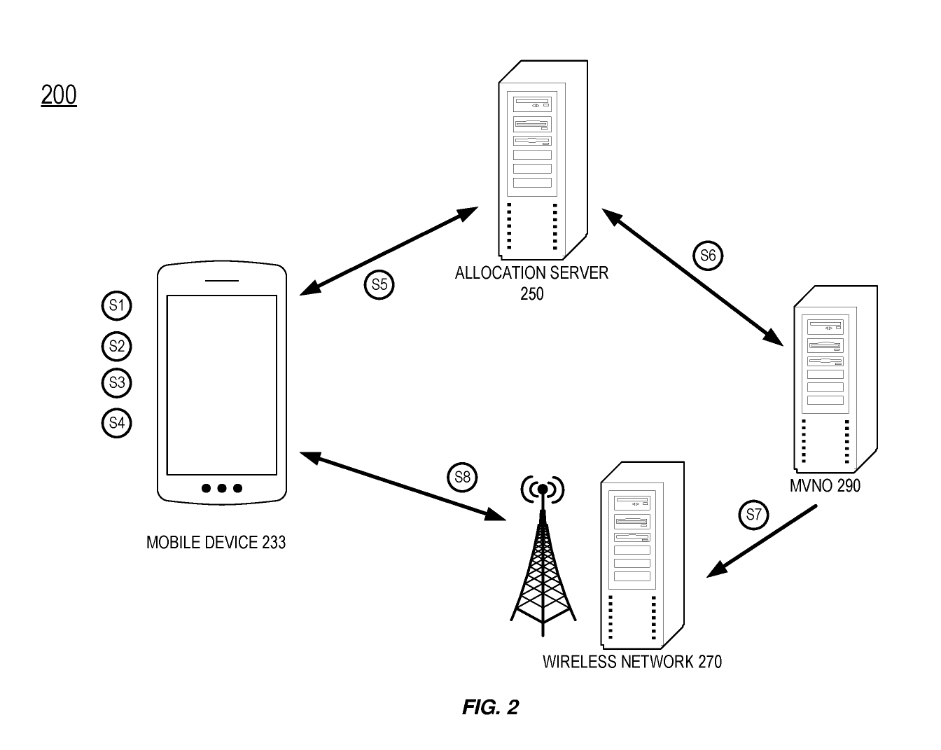

Referring to FIG. 2, mobile device 233 is an example of mobile device 790. Mobile device 233 may include the configurations of mobile device 10 of FIG. 1 and also include the lock-screen application functionality described with respect to FIGS. 7A-7D. System 200 includes mobile device 233, allocation server 250, MVNO server 290, and wireless network 270. Wireless network 270 includes the cellular infrastructure that may be owned by a cellular service provider. The cellular infrastructure includes the antennas and towers that facilitate cellular communication in addition to the back-end network of servers that connects the cellular towers to data networks such as the internet. MVNO 290 includes at least one server. MVNO 290 is networked to send and receive network packets with wireless network 270. Allocation server 250 is networked to send and receive network packets to MVNO 290. Allocation server 250 is also configured to establish a communication channel with mobile device 233. The communication channel may be via cellular data or via a WiFi connection. It is understood that each of the illustrated servers 250, 270, and 290 may be networked together using intervening internet networks and are not necessarily directly connected.

As an example illustration, a lock-screen application of mobile device 233 may render content to a display of the mobile device in process block S1, in FIG. 2. User interaction with the content displayed by the lock-screen application is received by the mobile device in process block S2. The user interactions with the content may be received by a touch screen interface and/or a camera of the mobile device, for example. The user interactions can be impressions of advertisements, downloading of additional content, participating in a survey, and/or initiating additional interaction with content (by swiping left), as examples. Other user interactions with the content displayed on the lock-screen application can also be measured, of course.

In process block S3, the mobile device (using processing logic 10C, for example) assigns an interaction value to a user profile based on the user interaction with the content. As discussed previously, downloading a mobile application associated with the content to the mobile device may have a higher interaction value than merely viewing an advertisement (an impression). Downloading a mobile application may have a value of 500 interaction credits, while an impression may have a value of 20 interaction credits, as an example. Assigning an interaction value to a user profile associated with lock-screen application may include caching the earned interaction credits locally within the memory 17 in memory space corresponding to the lock-screen application. Assigning an interaction value to a user profile associated with lock-screen application may also include transmitting an interaction credit message in a packet or series of packets to allocation server 250, where the user profile is stored remotely on allocation server 250. Allocation server 250 is operated by the owner/maker/publisher of the lock-screen application, in some embodiments.

In process block S4, a conversion input is received by the lock-screen application. The conversion input may be a software button selection within the lock-screen application. In response to receiving the conversion input, a conversion of interaction credits to a discrete unit of access to cellular service is initiated in process block S5. The user may check her interaction credits attributed to her user profile using an interface of the lock-screen application. The user may decide to convert/redeem the interaction credits in her user profile to cellular service. The user may select a discrete unit of cellular service that she prefers to redeem the interaction credits for. For example, a user may decide to convert 2,000 interaction credits for a given amount of different cellular service categories such as wireless data, voice minutes, or text messages. The 2,000 interaction credits may be redeemed for 200 MB of data, 200 voice minutes, or 200 text messages, for example. The user may select how many interaction credits he prefers to redeem and which category of cellular service he prefers to redeem for by utilizing a user interface of the lock-screen application, in one embodiment. The user may also set an automatic redemption of his interaction credits once the user reaches a threshold number of interaction credits in his user profile. For example, a user may choose to automatically redeem 1000 user interaction credits for 100 MB of cellular data, as soon as the user profile reaches 1000 user interaction credits. The threshold number of interaction credits may be pre-determined and set by a user using the user interface of the lock-screen application. The category of cellular service for automatic redemption may also be selected by the user using the user interface of the lock-screen application.

When the user manually selects how many interaction credits to redeem and which category of cellular service to redeem for, a conversion request may be sent to allocation server 250 from mobile device 233 when the user manually initiates the redemption within the lock-screen application. The conversion request may include a quantity of the interaction credits to be converted into the discrete unit of cellular service and a category of the discrete unit of cellular service. The allocation server 250 will decrement the interaction credits associated with user profile of the user and provide the selected unit of cellular service for access by mobile device, in response to the conversion request. When the interaction credits are automatically converted/redeemed for a discrete unit of cellular service, allocation server 250 may simply decrement the interaction credits in a user profile by the pre-determined threshold in the process of redeeming those interaction credits for a pre-determined amount and category of cellular service corresponding to the number of interaction credits redeemed. Hence, the initiating of a conversion of the interaction credits to a discrete unit of cellular service may be performed by a conversion request sent by the mobile device 233 to server 250 or server 250 may initiate and perform the conversion entirely within server 250.

Once allocation server 250 has performed the redemption/conversion of the interaction credits to a discrete unit of cellular service, allocation server 250 may send an allocation message to MVNO 290 in process block S6. In one embodiment, allocation server 250 utilizes an API (Application Programming Interface) of the MVNO 290 to send the allocation message to MVNO 290. The allocation message may include a unique identifier associated with the mobile device so that the MVNO can allocate the discrete unit of cellular service to the correct mobile device by sending an access message to the wireless network 270 in process block S7. In one example, the unique identifier is a phone number. In one embodiment, the unique identifier is an IMEI (International Mobile Station Equipment Identity). Both the allocation message to the MVNO 290 and the access message to the wireless network 270 may include the unique identifier and the discrete unit (and category) of cellular service to be allocated to the mobile device. In one example, the allocation message includes the quantity 500, the category of text message, and the phone number that has access to the 500 text messages.

Since wireless network 270 has received the allocation message with the unique identification number from MVNO 290, wireless network 270 provides access to the discrete unit of cellular service linked to the mobile device associated with the unique identification number, in process block S8. Where the unique identifier is a phone number, the wireless network 270 may put that phone number on an authorized list to connect to cellular service for usage of the cellular service for up to the discrete unit of cellular service.

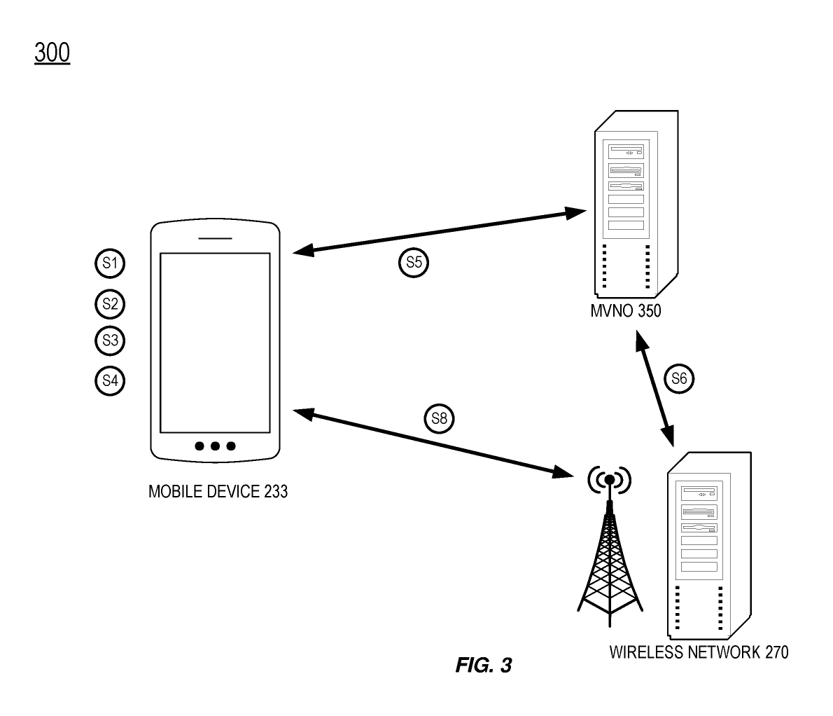

FIG. 3 illustrates system 300 that includes mobile device 233 and wireless network 270, and a hybrid allocation MVNO server 350. Server 350 is a hybrid because it includes the functionality of allocation server 250 and MVNO server 290. Server 350 is controlled by the same entity, in one embodiment, whereas allocation server 250 and MVNO server 290 may be controlled by different entities, in some embodiments. In system 300, server 350 receives the conversion requests from mobile device 233 and also allocates the cellular service. In one embodiment, the MVNO is the publisher (or is partnered with the publisher) of the lock-screen application installed on mobile device 233, which allows the MVNO to communicate with both the mobile device 233 and to wireless network 270. An MVNO may purchase cellular data, voice minutes, and text messages at a bulk wholesale rate from wireless network 270. Hence, when MVNO 350 receives a conversion request from the lock-screen application of mobile device 233, MVNO server 350 can decrement interaction credits from the user profile corresponding with the lock-screen application and then allocate a discrete unit of cellular service to mobile device 233 from the MVNO's bulk purchase of data, voice, and/or text from wireless network 270. MVNO server 350 may send an allocation message to wireless network 270 that includes the unique identification number and the discrete unit (and category) of cellular service to be allocated to the mobile device 233. In one example, the allocation message includes the quantity 500, the category of text message, and the phone number that has access to the 500 text messages.

Similar to system 200, since wireless network 270 has received the allocation message with the unique identification number from MVNO server 350, wireless network 270 provides access to the discrete unit of cellular service linked to the mobile device associated with the unique identifier in process block S8.

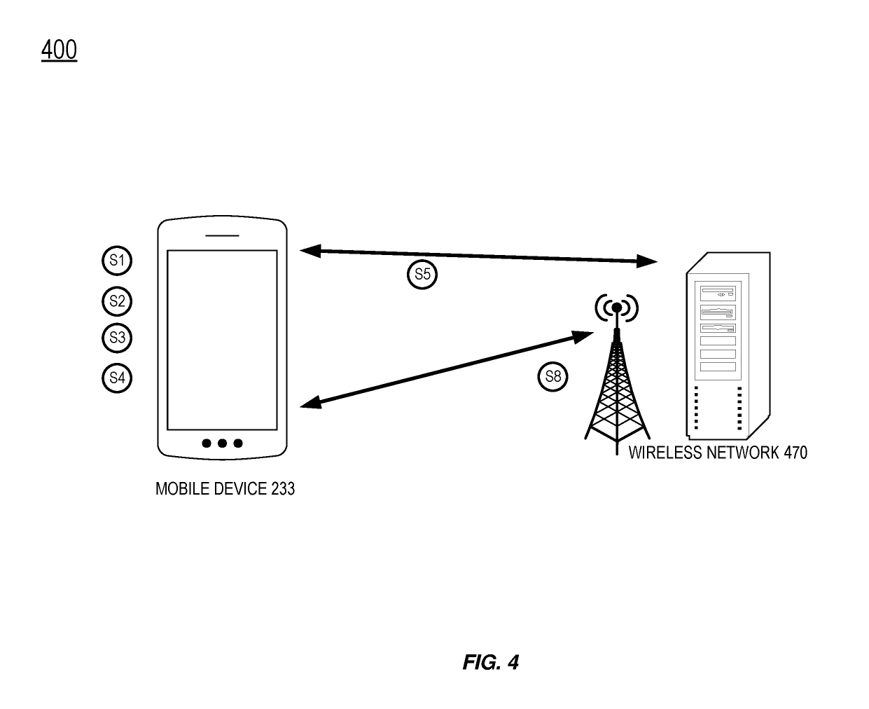

FIG. 4 illustrates a system 400 for allocating wireless communication access that includes a mobile device and a wireless network, in accordance with an embodiment of the disclosure. In system 400, wireless network receives the conversion requests from mobile device 233, converts the interaction credits to discrete units of cellular service as well as providing the cellular service. In one embodiment, the wireless network 470 is the publisher (or is partnered with the publisher) of the lock-screen application installed on mobile device 233. Hence, when wireless network server 470 receives a conversion request from the lock-screen application of mobile device 233, wireless network servers 470 can decrement interaction credits from the user profile corresponding with the lock-screen application and then provide access to a discrete unit of cellular service to mobile device 233 at process block S8. In system 400, the lock-screen application is highly integrated with the wireless network 470. In one embodiment, a user profile associated with the lock-screen application is the same or linked to account credentials for a user's cellular service. In other aspect, a user may pay an on-going fee to wireless network 470 for cellular service and have the option to decrease a portion of the recurring (e.g. monthly) fee or eliminate the recurring fee by redeeming interaction credits generated by interacting with the lock-screen application.

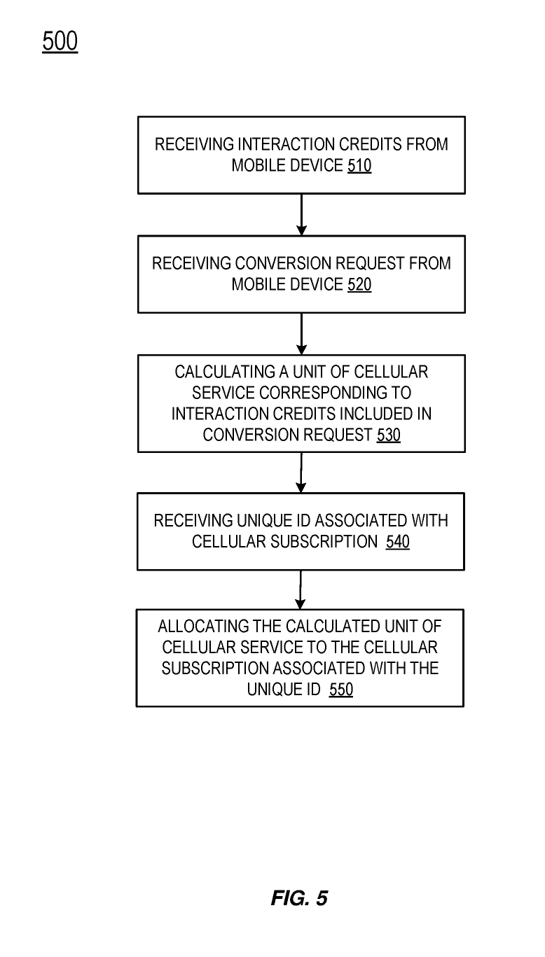

FIG. 5 illustrates an example method 500 of allocating a calculated unit of cellular service to a mobile device, in accordance with an embodiment of the disclosure. The order in which some or all of the process blocks appear in process 500 should not be deemed limiting. Rather, one of ordinary skill in the art having the benefit of the present disclosure will understand that some of the process blocks may be executed in a variety of orders not illustrated, or even in parallel.

In process block 510, interaction credits are received from a mobile device (e.g. mobile device 233). The interaction credits may be linked to a user account associated with a lock-screen application running on the mobile device. The interaction credits may be received via a network interface of a server computer.

In process block 520, a conversion request is received from the mobile device. The conversion request may be received via a network interface of a server computer. The conversion request includes a number of interaction credits included in the conversion request, in one embodiment.

In process block 530, a unit of cellular service corresponding to the number of interaction credits is calculated. For example, if a user of a mobile device wants to redeem 1000 interaction credits, processing logic of a server may calculate what unit of cellular service corresponds with the 1000 interaction credits. The category of cellular service for the interaction credits to be converted to may be specified within the conversion request.

In process block 540, a unique identifier associated with a cellular subscription utilized by the mobile device is received. The unique identifier is a cellular phone number in one embodiment. In one embodiment, the unique identifier is an IMEI. The unique identifier is included in the conversion request of process block 520, in some embodiments.

The calculated unit of cellular service is allocated to the cellular subscription associated with the unique identifier, in process block 550. Allocating the calculated unit of cellular service may includes sending an allocation message, as described in connection with FIGS. 2-3. The allocation message may include the unique identification number and the calculated unit of cellular service as well as the category of cellular service.

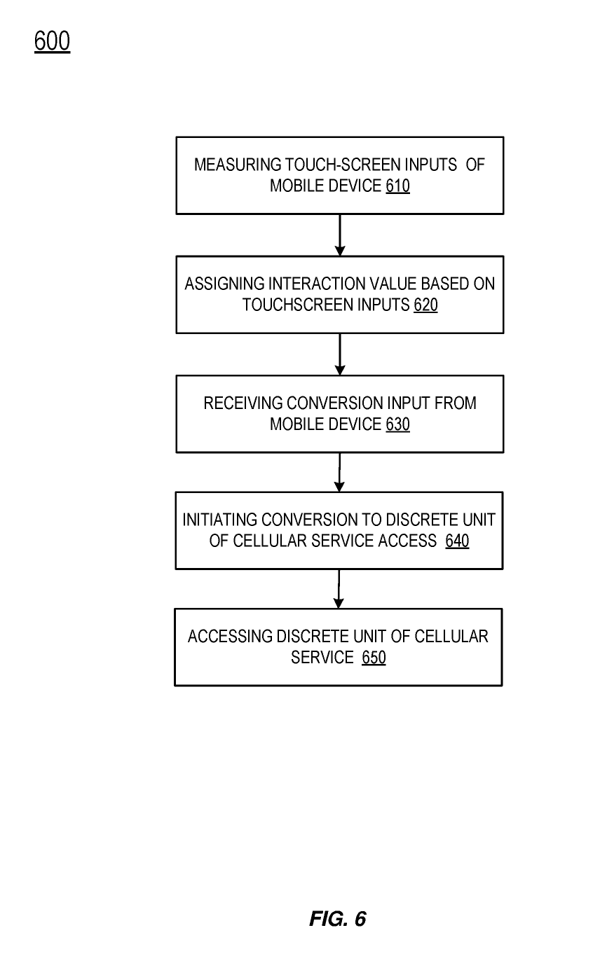

FIG. 6 illustrates an example method 600 of initiating an access allocation and accessing a unit of cellular service by a mobile device, in accordance with an embodiment of the disclosure. The order in which some or all of the process blocks appear in process 600 should not be deemed limiting. Rather, one of ordinary skill in the art having the benefit of the present disclosure will understand that some of the process blocks may be executed in a variety of orders not illustrated, or even in parallel.

In process block 610, touch-screen inputs of a mobile device are measured to determine a user interaction with content that is rendered to a lock-screen of a mobile device. An interaction value or a number of interaction credits is assigned to a user account based on the measured touch-screen inputs. For example, as discussed above, a user downloading a mobile application associated with content will be assigned more interaction credits than merely viewing or scrolling through content of a lock-screen.

A conversion input is received from a touch-screen interface of a mobile device in process block 630. In one example, the user uses a software interface of the lock-screen to select a conversion software button that converts interaction credits to a discrete unit of a specific category of cellular service. In response to the mobile device receiving the conversion input (e.g. selection of a software conversion button), processing logic of the mobile device initiates a conversion of the interaction credits to a discrete unit of cellular service in process block 640. In one embodiment, initiating a conversion of the interaction credits includes transmitting a conversion request to a remote server. After the conversion, the mobile device can access the discrete unit of cellular service in process block 650. The discrete unit of cellular service is associated with the conversion of the interaction credits initiated in process block 640.

A particular example method of the disclosure includes rendering content to a lock-screen of a mobile device, measuring a user interaction with the content rendered to the lock-screen, adding credits to a user profile based on the measured user interaction, initiating a conversion of the credits to a discrete unit of wireless communication in response to a receiving a conversion request from a user of the mobile device, and utilizing (with a mobile device, for example) at least a portion of the discrete unit of the wireless communication service after initiating the conversion of the credits. Although the bulk of this disclosure is directed to a user interacting with lock-screen content to earn cellular service, other wireless communication access may also be allocated using the teaching of this disclosure. For instance, WiFi access could also be allocated. In the context of an airplane, a user could interact with content of the lock-screen to earn interaction credits to be redeemed for a discrete unit (e.g. 15 minutes) of in-flight WiFi access.

The advantages of the disclosure include not having to enter payment credentials (e.g. credit card numbers) to access cellular service, which increases a user's data security. Additionally, a user is able to transform their interactions with content of a lock-screen application to access into cellular service. When a user needs additional cellular data for example, interacting with the lock-screen to earn additional access to cellular data, for example, may be more efficient than purchasing additional cellular data via telephone call or in-store purchase. Furthermore, a granularity of the discrete units of cellular service that are available for redemption can be much more cost effective than purchasing the additional units from a carrier. For example, rather than purchase an additional 1 GB of cellular data at the end of the month that the user is unlikely to use all of, a user has the option to earn a smaller unit (e.g. 100 MB) of cellular data to be used for the end of the month rather than overpaying for an allotment that they are unlikely to use. In this way, the allocation of wireless communication access is more efficient.

Throughout the disclosure, a lock-screen application has been described and the features described above are generally accessible via the lock-screen of the lock-screen application. In addition, the features described above may also be implemented and be accessible through a more traditional mobile application that is accessible to a user after unlocking a lock-screen or the lock-screen application described herein. For example, in addition to earning credits in the lock-screen environment, users may also earn credits by participating in surveys, viewing advertisements, using electronic coupons, downloading content related to advertisements (as examples) in the more traditional mobile application that is accessible to the user after unlocking the lock-screen. The lock-screen application and the mobile application may share similar features. A user profile of the lock-screen application may be the same as a user profile of the mobile application accessible after unlocking the lock-screen application. In this way, the user can earn credits that are assigned to the same user profile by either earning credits within the lock-screen application or earning credits within the mobile application accessible after unlocking the lock-screen of the lock-screen application. The more traditional mobile application and the lock-screen application are separate applications, in one embodiment.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A mobile device comprising:
a display;
a touch-screen interface disposed with the display;
an antenna configured to send and receive cellular data;
processing logic coupled to drive images to the display and coupled to receive inputs from the touch-screen interface; and
a computer-readable medium communicatively coupled to the processing logic, wherein instructions stored in the computer-readable medium cause the mobile device to execute operations comprising:
rendering, from a lock-screen of the mobile device, content to the display;
receiving, from the touch-screen interface, user interactions with the content from the lock-screen that is rendered to the display of the mobile device;
assigning an interaction value to a user profile based on the user interaction with the content;
receiving, from the touch-screen interface, a conversion input;
initiating a conversion of the interaction value to a discrete unit of access to cellular service in response to receiving the conversion input; and
receiving access to the cellular service for the discrete unit of cellular service associated with the conversion of the interaction value to the discrete unit of cellular service.

2. The mobile device of claim 1, wherein initiating a conversion of the interaction value to a discrete unit of access includes transmitting a conversion request from the mobile device to a server, wherein the conversion request includes a quantity of the interaction value to be converted into the discrete unit of access to cellular service.

3. The mobile device of claim 1 further comprising a global positioning satellite (GPS) receiver communicatively coupled to the processing logic, wherein the computer-readable medium further provides instructions that, when executed by the processing logic, will cause the mobile device to perform further operations comprising:
receiving a GPS coordinate from the GPS receiver;
transmitting the GPS coordinate to a remote server;
receiving location-relevant content that is associated with the GPS coordinate; and
rendering the location-relevant content to the display as part of the content displayed on the lock-screen interface.

4. The mobile device of claim 1, wherein the mobile device is at least one of a tablet or a smartphone.

5. The mobile device of claim 1, wherein the content includes advertisements, and wherein the user interaction includes scrolling through a plurality of the advertisements, and further wherein assigning the interaction value includes measuring a number of the impressions that the plurality of the advertisements received.

6. The mobile device of claim 1, wherein the content includes surveys, and wherein the user interaction includes providing answers to the surveys, and further wherein assigning the interaction value includes identifying a number of surveys that have been completed by a user of the mobile device.

7. The mobile device of claim 1, wherein the computer-readable medium further provides instructions that, when executed by the processing logic, will cause the mobile device to perform further operations comprising:
sensing, with the touch-screen interface, a swipe-left over the content rendered in the lock-screen; and
rendering, in response to sensing the swipe-left, a download page to download an application associated with the content.

8. The mobile device of claim 7, wherein the computer-readable medium further provides instructions that, when executed by the processing logic, will cause the mobile device to perform further operations comprising:
receiving a completion message indicating the application associated with the content has been downloaded to the mobile device, wherein said assigning the interaction value to a user profile includes increasing the interaction value in response to receiving the completion message.

9. The mobile device of claim 1, wherein assigning the interaction value to a user profile includes sending an increment request to a remote server.

10. A method of allocating cellular service access, the method comprising:
receiving, via a network interface, interaction credits from a mobile device, wherein the interaction credits are accumulated by the mobile device measuring user interaction with content rendered to a lock-screen of the mobile device;
receiving, via the network interface, a conversion request from the mobile device, wherein the conversion request includes a number of the interaction credits for converting;
calculating, with processing logic, a unit of cellular service corresponding to the number of interaction credits included in the conversion request;
receiving, via the network interface, a unique identifier associated with a cellular subscription used by the mobile device; and
allocating the calculated unit of cellular service to the cellular subscription associated with the unique identifier.

11. The method of claim 10, wherein allocating the calculated unit of cellular service to the cellular subscription includes:
transmitting, via the network interface, an allocation message to a server, the allocation message including the unique identifier and the calculated unit of cellular service.

12. The method of claim 10 further comprising:
receiving a location indicator of the mobile device;
identifying location-relevant content in a content database, wherein the location relevant content is associated with a geo-location proximate to the location indicator of the mobile device; and
transmitting the location-relevant content to the mobile device.

13. The method of claim 12, wherein the location indicator is a GPS coordinate.

14. The method of claim 10, wherein the unique identifier is at least one of a phone number or an International Mobile Station Equipment Identity (IMEI).

15. The method of claim 10, wherein allocating the calculated unit of cellular service includes transmitting an allocation message to a cellular network provider that provides the cellular subscription associated with the unique identifier, the allocation packet including the unique identifier and the calculated unit of cellular service.

16. The method of claim 10, wherein the conversion request from the mobile device specifies a category of the unit of cellular service that the interaction credits are to be converted into.

17. The method of claim 16, wherein the unit of cellular service is at least one of a number of voice minutes, a number of text messages, or a cellular data allotment.

18. A non-transitory machine-accessible storage medium that provides instructions that, when executed by a mobile device, will cause the mobile device to perform operations comprising:
rendering content to a display of the mobile device;
receiving, from a touch-screen interface of the mobile device, user interactions with the content rendered to the display;
assigning an interaction value to a user profile based on the user interaction with the content;
receiving, from the touch-screen interface, a conversion input;
initiating a conversion of the interaction value to a discrete unit of access to a wireless communication network in response to receiving the conversion input; and
receiving access to the wireless communication network for the discrete unit associated with the conversion of the interaction value.

19. The non-transitory machine-accessible storage medium of claim 18, wherein the wireless communication network includes a cellular service network, and wherein the discrete unit of access to the wireless communication network is a cellular data allotment.

20. The non-transitory machine-accessible storage medium of claim 18, wherein the wireless communication network includes a WiFi access point, and wherein the discrete unit of access to the wireless communication network is a time period of access to the WiFi access point.
